(19) United States
(12) Patent Application Publication
(10) Pub. No.: US 2018/0316798 A1
(43) Pub. Date: Nov. 1, 2018

(54) COMMUNICATION SYSTEM, COMMUNICATION METHOD, AND COMMUNICATION ADAPTER

(71) Applicant: Panasonic Intellectual Property Management Co., Ltd., Osaka (JP)

(72) Inventors: Ikko FUJIMURA, Osaka (JP); Miki AYUKAWA, Osaka (JP); Shinji IKEGAMI, Osaka (JP); Masao OHMOTO, Osaka (JP); Shinji KIMURA, Osaka (JP); Masahisa OKUDA, Osaka (JP)

(21) Appl. No.: 15/730,109

(22) Filed: Oct. 11, 2017

(30) Foreign Application Priority Data
Apr. 28, 2017 (JP) 2017-090039

(51) Int. Cl. H04M 9/00; H04L 29/08; H04W 68/00; H04M 1/02

(52) U.S. Cl. CPC H04M 9/008; H04L 67/26; H04M 2242/40; H04M 1/0202; H04W 68/005

(57) ABSTRACT

In a communication system, a PBX, a smartphone, and a communication adapter are connected. When detecting an event related to a call such as an incoming call and an outgoing call, the communication adapter transmits information on the event to the smartphone through BLE communication with the smartphone. The smartphone makes a notification of the occurrence of the event, based on the information on the event transmitted from the communication adapter. After the notification of the occurrence of the event, the communication adapter transmits an Invite command, “180” command, or the like to the PBX.

### BACKGROUND

### 1. Technical Field

The present disclosure relates to a communication system, a communication method, and a communication adapter, each of which transmits and receives a signal about a call.

### 2. Description of the Related Art

Generally, in an office of a company or the like, a portable telephone communication terminal (hereinafter, referred to as “business telephone communication terminal”) which can be used for internal telephone calls and the like is distributed to individual employees. Each employee uses the business telephone communication terminal to make a call with an external party through a telephone exchange (PBX: private branch exchange) installed in a company.

On the other hand, in recent years, considering that many individual employees possess private smart phones, there is a need that the business telephone communication terminals are not distributed to individual employees, and each employee uses his or her own smart phone to make a call with an external party through the PBX installed in the company. In other words, it is desired to improve the convenience by employing the smart phone of an individual employee as a cordless phone slave device for the PBX.

Here, in a cordless telephone apparatus disclosed in Japanese Patent Unexamined Publication No. 2014-239296, it is disclosed that a resident's smartphone is connected to a cordless telephone master device through a wireless LAN, and the smartphone can be used as a cordless telephone slave device for the cordless telephone master device, inside and outside premises.

In Japanese Patent Unexamined Publication No. 2014-239296, it is disclosed that a smartphone possessed by a user can be registered and used as a cordless slave device for a cordless master device in a house. However, according to the related art as disclosed in Japanese Patent Unexamined Publication No. 2014-239296, it is not assumed that the smartphone possessed by the user is used, for example, as a business cordless telephone which can be connected to a telephone exchange installed in a company or the like.

Therefore, for example, when an event (for example, an incoming call or an outgoing call) related to a call occurs on a business basis, a user (that is, an employee) is required to pick up his or her smartphone and perform necessary operations one by one according to the contents of the event related to the call. However, this may lead to a decrease in operational efficiency in such a manner that sometimes operability using his or her smartphone is not good at work and at least some of his or her work may be stagnant, even for a user who is unfamiliar with such an operation.

### SUMMARY

The present disclosure has been made in view of the above-described circumstances in the related art, and an object of the present disclosure is to provide a communication system, a communication method, and a communication adapter which suppress deterioration in operability when a user's smartphone is used as a cordless telephone in business, and can support improvement of operational efficiency, even for a user who is unfamiliar with a necessary operation according to the content of an event related to a call.

The present disclosure provides a communication system including a telephone exchange, a telephone communication terminal, and a communication adapter that transmits and receives a signal about a call between the telephone exchange and the telephone communication terminal, in which the telephone exchange, the telephone communication terminal, and the communication adapter are connected with each other, the communication adapter transmits information on an event to the telephone communication terminal by first communication with the telephone communication terminal, when detecting the event related to the call, the telephone communication terminal makes a notification of an occurrence of the event, based on the information on the event transmitted from the communication adapter, and the communication adapter transmits a signal indicating completion of response preparation for the event in the telephone exchange, to the telephone exchange, after the notification of the occurrence of the event.

According to the present disclosure, it is possible to suppress deterioration in operability when a user's smartphone is used as a cordless telephone in business, and support improvement of operational efficiency, even for a user who is unfamiliar with a necessary operation according to the content of an event related to a call.

### BRIEF DESCRIPTION OF THE DRAWINGS

FIG. 1 is a diagram illustrating an outline of a configuration of a communication system according to Exemplary Embodiment;

FIG. 2A is a front view showing an operation panel of a communication adapter;

FIG. 2B is a perspective view showing an appearance of the communication adapter;

FIG. 2C is a side view showing the appearance of the communication adapter;

FIG. 3 is a block diagram showing a hardware configuration of the communication adapter;

FIG. 4 is a block diagram showing a hardware configuration of a smartphone;

FIG. 5 is a sequence diagram showing an initial connection operation between the communication adapter and the smartphone;

FIG. 6 is a sequence diagram showing second and subsequent connection operations between the communication adapter and the smartphone;

FIG. 7 is a diagram showing a screen transition of the smartphone when starting IP communication connection with the communication adapter;

FIG. 8 is a sequence diagram showing an incoming call operation procedure in a case where the communication adapter makes an incoming call response;

FIG. 9 is a sequence diagram showing an incoming call operation procedure in a case where the communication adapter makes the incoming call response subsequent to FIG. 8;

FIG. 10 is a sequence diagram showing an incoming call operation procedure when the smartphone makes an incoming call response;

FIG. 11A is a diagram showing an incoming call screen;

FIG. 11B is a diagram showing a talking screen;

FIG. 11C is a diagram showing an outgoing call screen;

FIG. 11D is a diagram showing an idle screen;

FIG. 12 is a sequence diagram showing an outgoing call operation procedure;

FIG. 13 is a sequence diagram showing an outgoing call operation procedure subsequent to FIG. 12;

FIG. 14 is a sequence diagram showing a call transfer operation;

FIG. 15 is a sequence diagram showing a call transfer operation subsequent to FIG. 14; and

FIG. 16 is a sequence diagram showing a call transfer operation subsequent to FIG. 14 and FIG. 15.

### DETAILED DESCRIPTION

### Background to Achieve the Contents of Exemplary Embodiment 1

In the above-mentioned Japanese Unexamined Patent Application Publication No. 2014-239296, it is disclosed that a smartphone possessed by a user can be registered and used as a cordless slave device for a cordless master device in a house. However, according to the related art as disclosed in

Japanese Patent Unexamined Publication No. 2014-239296, it is not assumed that the smartphone possessed by the user is used, for example, as a business cordless telephone which can be connected to a telephone exchange installed in a company or the like.

For example, an event related a call (for example, an incoming call from a telephone of a call partner) may occur, and the event may be transferred to a telephone used by another person. In the related art as disclosed in Japanese Patent Unexamined Publication No. 2014-239296, a configuration is not disclosed in which a user (that is, an employee) performs a prompt situation checking as to whether or not the person (for example, an employee of the same department as the user) is present. Therefore, it is necessary for the user to perform troublesome operations such as operating a smartphone to hold a call with a call partner and transfer the call, while delaying at least a part of his or her work, for example. In a case where the person at the transfer destination (that is, the different person described above) is not present, there is a problem that it is necessary to correspond with the call party who has made a call such as releasing the hold and to calling back to the call party, cumbersome work is required for the user, and the efficiency of the operation at the time of transfer using the telephone communication terminal is lacking.

Therefore, in Exemplary Embodiment 1, a description will be made about a communication system, communication method, and communication adapter, which quickly checks whether a different person is present or not, and can efficiently support the transfer of the incoming call to the telephone of the different person, as necessary, in a case where an incoming call from the telephone of the call party occurs and the incoming call is transferred to the telephone of the different person.

### Exemplary Embodiment 1

Hereinafter, each exemplary embodiment specifically disclosing the communication system, the communication method, and the communication adapter according to the present disclosure will be described in detail with reference to the drawings as appropriate. However, detailed description more than necessary may be omitted in some cases. For example, detailed descriptions of already well-known matters and duplicate descriptions for substantially the same components may be omitted in some cases. This is to avoid the following description from being unnecessarily redundant and facilitate the understanding of those skilled in the art. In addition, the accompanying drawings and the following description are provided in order to help those skilled in the art fully understand the present disclosure, and are not intended to limit the subject described in claims The communication system according to the following exemplary embodiments will be described assuming a case where it is installed in an office of a company or the like, for example, the installation destination is not limited to the office of a company or the like.

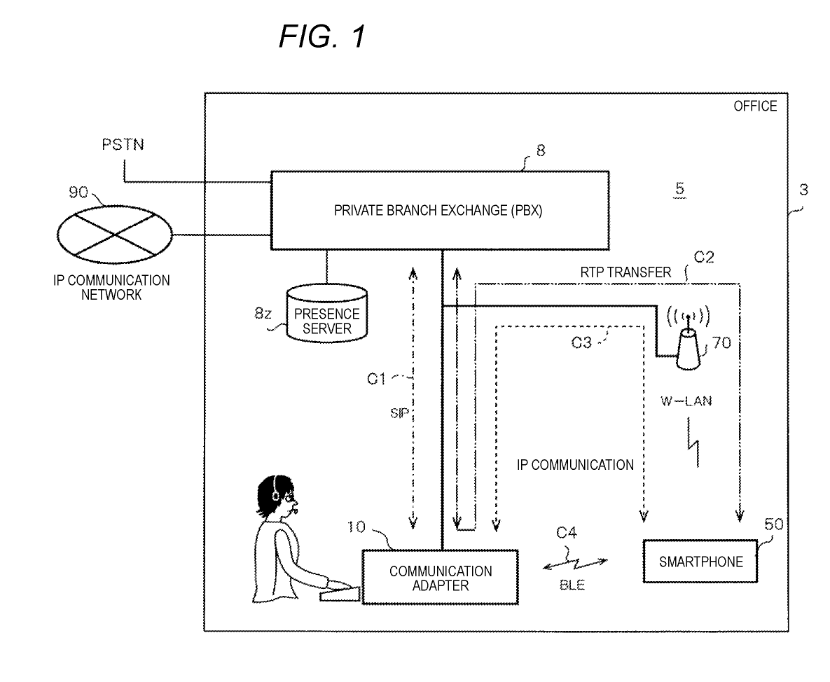

FIG. 1 is a diagram illustrating an outline of a configuration of communication system 5 according to Exemplary Embodiment 1.

Communication system 5 is installed, for example, in an office in building 3 such as a company, and has a configuration including Private Branch eXchange (PBX) 8, communication adapter 10, and smartphone 50. In order to explain the configuration of communication system 5 in an easy-to-understand manner, only one smartphone 50 is shown, but since smartphones 50 are possessed by individual employees in the office, it goes without saying that the number of smartphones 50 constituting communication system 5 is not limited to one.

PBX 8 is called a private branch exchange (so-called private telephone exchange) or a telephone exchange.

PBX 8 is connected to an IP communication network (LAN: Local Area Network) 90 such as Ethernet (registered trademark), and relays a call between an external telephone (not shown) connected to IP communication network 90 and the telephone in the company. Further, PBX 8 is connected to public switched telephone network (PSTN) 100, and relays a call between an external telephone connected to public switched telephone network 100 and a telephone in the company. PBX 8 is connected to presence server 8z. Presence server 8z retains a table that manages the presence state and call state of each employee (each user) who is the user of the desk on which each communication adapter 10 provided corresponding to an individual user (that is, an employee) is placed. In FIG. 1, presence server 8z is illustrated as a separate entity from PBX 8, but presence server 8z may be provided inside PBX 8.

Communication adapter 10 is connected to PBX 8 and an in-house local area network (LAN). Communication adapter 10 relays a call between smartphone 50 wirelessly connected through access point (AP) 70 connected to the in-house LAN and PBX 8 connected through the in-house LAN. Communication adapter 10 is wirelessly connected to smartphone 50 by Bluetooth (registered trademark) Low Energy (BLE) communication.

Smartphone 50 is connected to access point 70 through a wireless LAN, and is capable of communicating with an external (for example, a business partner) telephone (such as a mobile phone terminal, not shown) connected to PBX 8 through access point 70. Smartphone 50 is wirelessly connected to communication adapter 10 by Bluetooth (registered trademark) Low Energy (BLE) communication, and is also connected to communication adapter 10 through access point 70 and the in-house LAN (in other words, IP communication function).

In the IP communication between PBX 8 and communication adapter 10, session establishment and disconnection are performed (see reference character C1) by using session initiation protocol (SIP) which is a protocol for performing call control and the like of the IP call. The IP communication between PBX 8 and communication adapter 10 is not limited to the case of using the SIP described above, and may be realized by using media gateway control protocol (MGCP), for example.

The voice data between PBX 8 and smartphone 50, which is relayed by communication adapter 10, is transferred using Real-time Transport Protocol (RTP) communication which is a data communication protocol for transmitting a voice data stream in real time (see reference character C2).

IP communication and BLE communication are performed between communication adapter 10 and smartphone 50. In the IP communication between communication adapter 10 and smartphone 50, call control information, RTP information, linkage function control information, and the like are transferred (see reference character C3). In the BLE communication between communication adapter 10 and smartphone 50, IP information and the like (including an IP address and a port number) are transferred (see reference character C4).

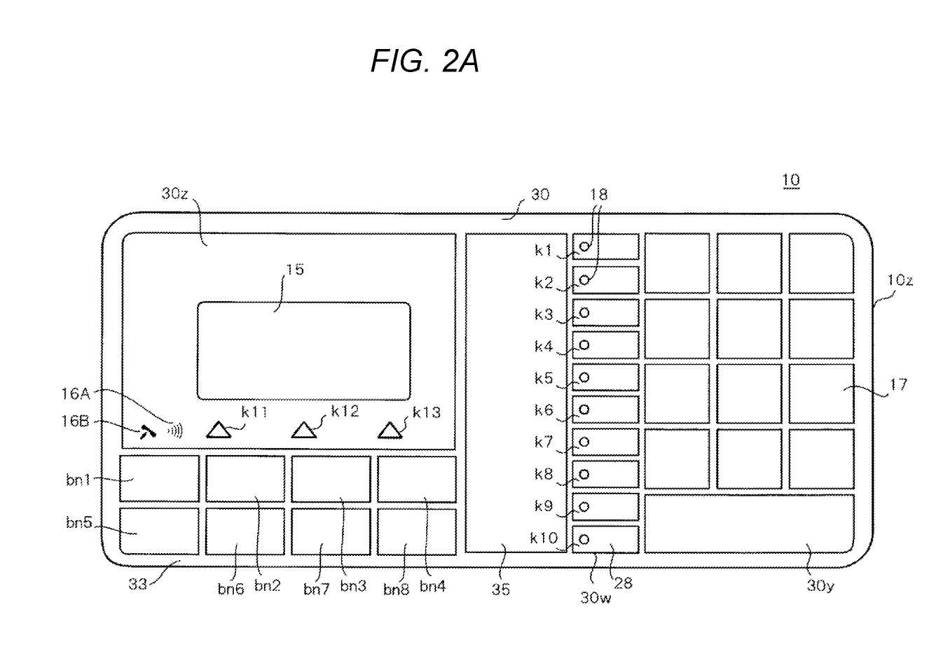

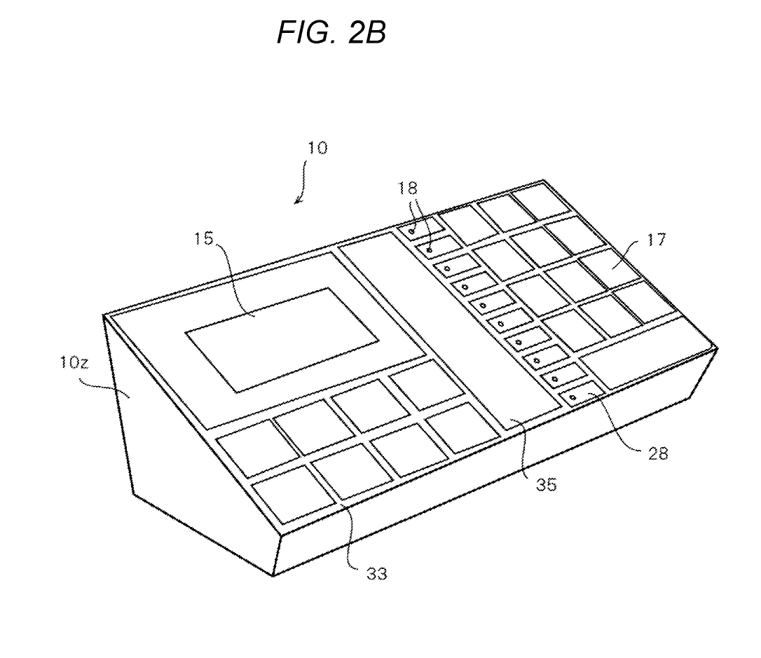

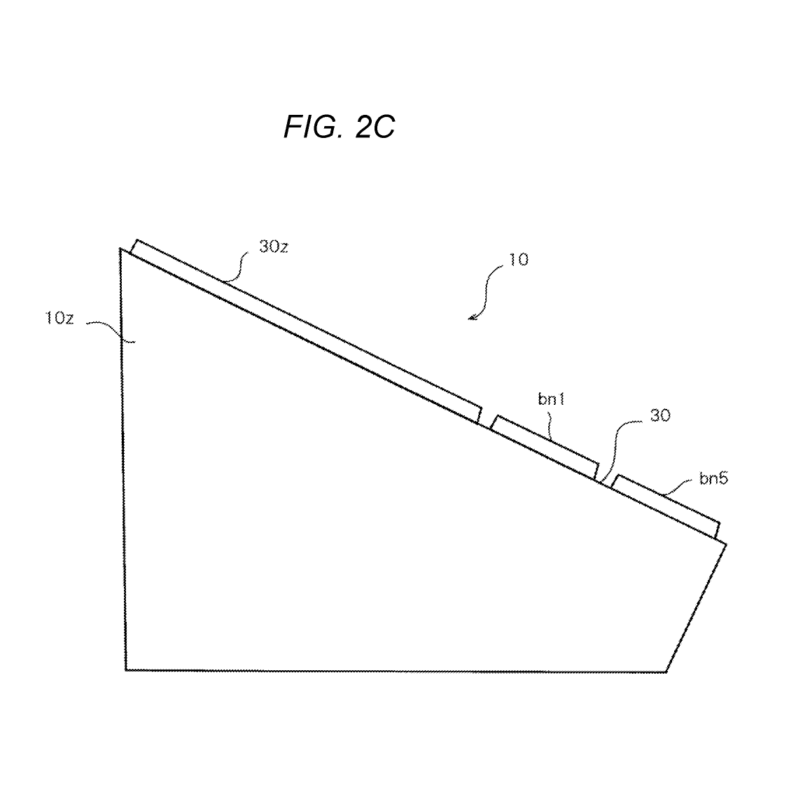

FIG. 2A is a front view showing operation panel 30 of communication adapter 10.

FIG. 2B is a perspective view showing an appearance of communication adapter 10.

FIG. 2C is a side view showing the appearance of communication adapter 10.

Communication adapter 10 has box-shaped casing 10z whose upper surface is inclined to the front side. Casing 10z is formed of, for example, a resin material. Operation panel 30 is disposed on the upper surface of casing 10z. The front surface of operation panel 30 is partitioned into display region 30z, button region 30y, blank region 30x, BLF key region 30w, and a 12-key region.

In display region 30z, liquid crystal display (LCD) 15 is disposed at the center, and incoming call LED 16B, BLE LED 16A, and soft key group 34 are disposed below LCD 15. Soft key group 34 includes soft keys k11, k12, and k13. Button group 33 is disposed in button region 30y. Button group 33 includes CALL button bn1, TRANSFER button bn2, HOLD button bn3, REDIAL button bn4, MUTE button bn5, MESSAGE button bn6, Recording button bn7, and CANCEL button bn8.

CALL button bn1 is pressed when user makes a call or transfers a call. CALL button bn1 is pressed when the user terminates talking during the call.

TRANSFER button bn2 is pressed when the user transfers a call.

HOLD button bn3 is pressed when user holds a call.

REDIAL button bn4 is pressed when the user redials a call.

MUTE button bn5 is pressed when the user stops sending a call.

MESSAGE button bn6 is pressed when reproducing an answering machine.

Recording button bn7 is pressed when the user plays an answering machine.

CANCEL button bn8 is pressed when ending the call. CANCEL button bn8 is also pressed when the user cancels each operation. Blank area 30x is blank. For example, a tag seal on which a user has written a memo or the like may be pasted in blank region 30x. The name of the user corresponding to a BLF key to be described later may be written.

BLF key group 28 is disposed in BLF key region 30w. BLF key group 28 includes ten BLF keys k1 to k10. Instead of dialing using 12-key 17 to be described later, each of BLF keys k1 to k10 is a hard key that can transfer a call to smartphone 50 having the registered number by a one-touch operation, or can make a call to smartphone 50 having the registered number. Each of BLF keys k1 to k10 includes BLF key LED 18. The phones capable of transferring calls and making calls in accordance with pressing each of BLF keys k1 to k10 are not limited to smartphone 50, but may be a telephone communication terminal (for example, an IP telephone, and an analog telephone) connected to PBX 8.

Each of BLF key LEDs 18 displays the presence state and the call state of the user of corresponding smartphone 50. Therefore, the presence status and call status of the users of which the number of smartphones 50 are registered in BLF keys k1 to k10 are obvious. The presence state and call state of all the users in the company are registered and managed in the table of presence server 8z of PBX 8 described above.

Upon receiving notification of the presence state and call state of the corresponding user from PBX 8, communication adapter 10 changes the lighting color of BLF key LED 18 corresponding to the number of the corresponding user. Here, in a case where LED 18 is turned off (that is, it is not lit), it indicates that the user is present. In a case where the lighting color of LED 18 is red, it indicates that the user is absent or is talking on the phone. In a case where the user is present, the lighting color of BLF key LED 18 may be set to a different color depending on the talking or non-talking on the phone. BLF key LED 18 is not limited to the presence state or the call state, but may display in detail in distinguishable manner, the state of the user such as “present but do not answer the phone”, and “meeting in progress”, depending on the type of work being handled by the user. For example, the lighting color of BLF key LED 18 may be changed to a lighting color other than red or green, or it may be lit by changing the lighting count or blinking count. 12-key 17 is disposed in the 12-key region. 12-key 17 includes numeric keys “0” to “9” capable of inputting numerical values, and symbol keys of “*” and “#”.

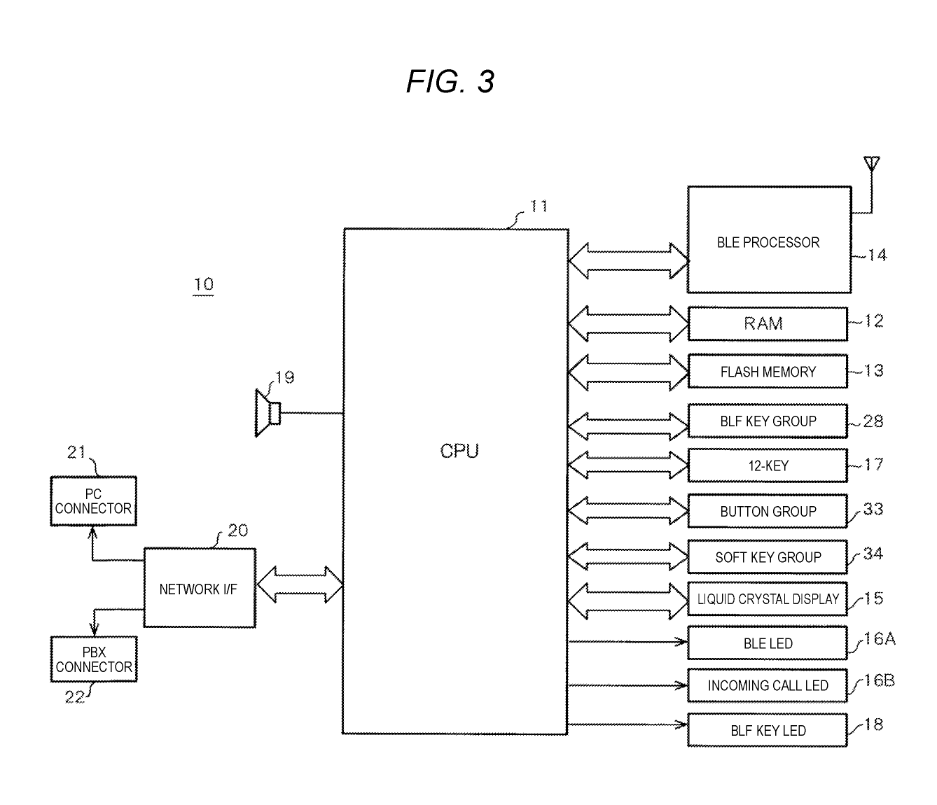

FIG. 3 is a block diagram showing a hardware configuration of communication adapter 10.

Communication adapter 10 includes CPU 11, RAM (volatile memory) 12, flash memory (nonvolatile memory) 13, BLE processor (BLE module) 14, liquid crystal display 15, BLE LED 16A, incoming call LED 16B and BLF key LED 18.

CPU 11 cooperates with RAM 12 and flash memory 13, which are memories, to control the execution of various control processes and performs overall control of the operation of communication adapter 10.

RAM (volatile memory) 12 is used as a working memory of CPU 11. For example, the presence state and call state of the user corresponding to each of BLF keys k1 to k10 are stored in RAM 12, based on the data received from PBX 8. BLF key LED 18 is lit based on the information on the presence state and call state stored in RAM 12.

Flash memory 13 is a nonvolatile memory, and stores registration information and the like of communication adapter 10. Examples of the registration information include the number of smartphone 50 possessed by the user corresponding to the BLF key.

BLE processor (an example of the BLE module) 14 performs BLE communication with smartphone 50.

Liquid crystal display 15 is a display capable of displaying, for example, information and data of four rows, and displays the name, number, or the like of a call destination notified from PBX 8.

BLE LED 16A indicates the connection state of the BLE communication between smartphone 50 and communication adapter 10, and it is lit when the BLE communication is possible (that is, the connected state by BLE). Incoming call LED 16B blinks when there is an incoming call from PBX 8, and is turned off by disconnection of the call after the incoming call is received. Incoming call LED 16B also indicates a state where the message sent from the telephone of the call partner due to a missed call is saved.

As described above, communication adapter 10 includes buzzer 19 and network interface (I/F) 20 as well as 12-key 17, BLF key group 28, button group 33, soft keys k11 to k13.

Buzzer 19 makes a sound, for example, when there is an incoming call. Network I/F (IP communication function) 20 controls the IP communication network (LAN), and connects communication adapter 10 and IP communication network 90.

Network I/F 20 includes PC connector 21 and PBX connector 22, is connected to the user PC through PC connector 21, and is also connected to PBX 8 and access point 70 through PBX connector 22.

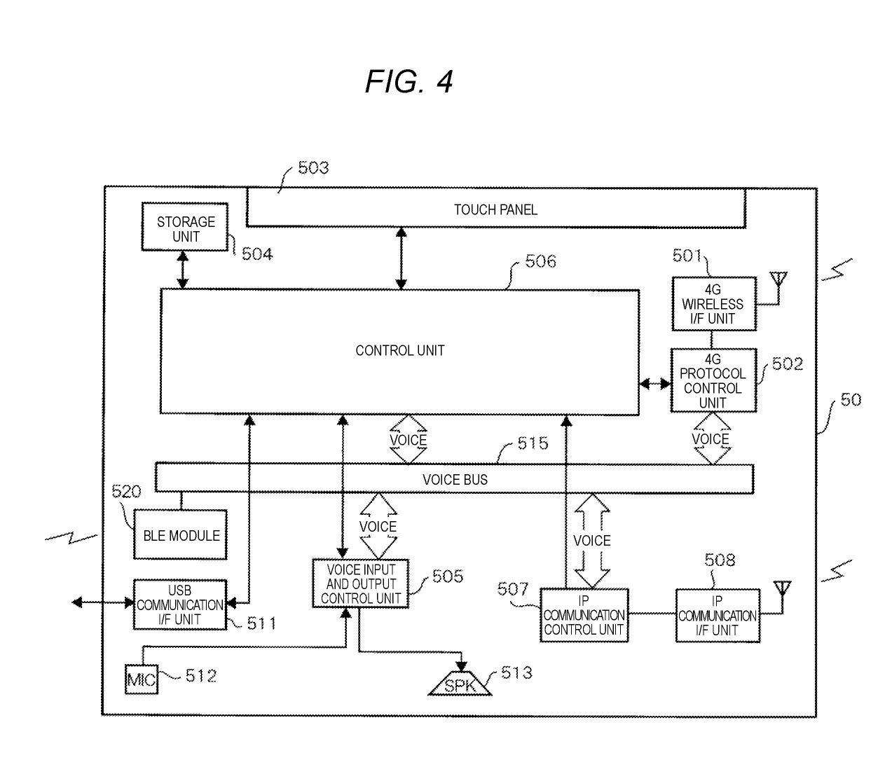

FIG. 4 is a block diagram showing a hardware configuration of smartphone 50.

Smartphone 50 includes controller 506, storage 504, and touch panel 503.

Controller 506 cooperates with a memory (for example, storage 504) to control the execution of various control processes and performs overall control of the operation of smartphone 50.

Storage 504 stores programs and data necessary for the operation of smartphone 50, as well as application programs and the like used by the user.

Touch panel 503 accepts a touch input operation (such as a tap operation) by the user, and also displays images, icons, and the like on the screen.

Smartphone 50 includes 4G protocol controller 502 and 4G wireless I/F unit 501, and performs wireless connection with a mobile phone or another smartphone connected to a mobile network, by using a 4G wireless communication system (fourth generation mobile communication system), for example. The communication standard that smartphone 50 can deal with is not limited to 4G (fourth generation mobile communication system), but may be other communication standards such as 3G (third generation mobile communication system), and 5G (fifth generation mobile communication system).

Smartphone 50 includes voice bus 515, voice input and output controller 505, speaker 513, and microphone 512, and performs input and output of sound to and from the outside.

Smartphone 50 includes IP communication controller 507 and IP communication I/F unit 508, and transmits and receives voice data to and from PBX 8 and communication adapter 10 through access point 70 connected through a wireless LAN.

Smartphone 50 includes BLE module 520, and performs a connection process (for example, pairing) for performing BLE communication with communication adapter 10 by using the communication standard of Bluetooth (registered trademark) Low Energy (BLE), and performs communication after the connection.

Smartphone 50 includes USB communication I/F unit 511, and exchanges data with devices, memories, or the like including an interface of the universal serial bus (USB) standard. Next, the operation of communication system 5 according to the present exemplary embodiment will be described with reference to the drawings.

### Connection Operation

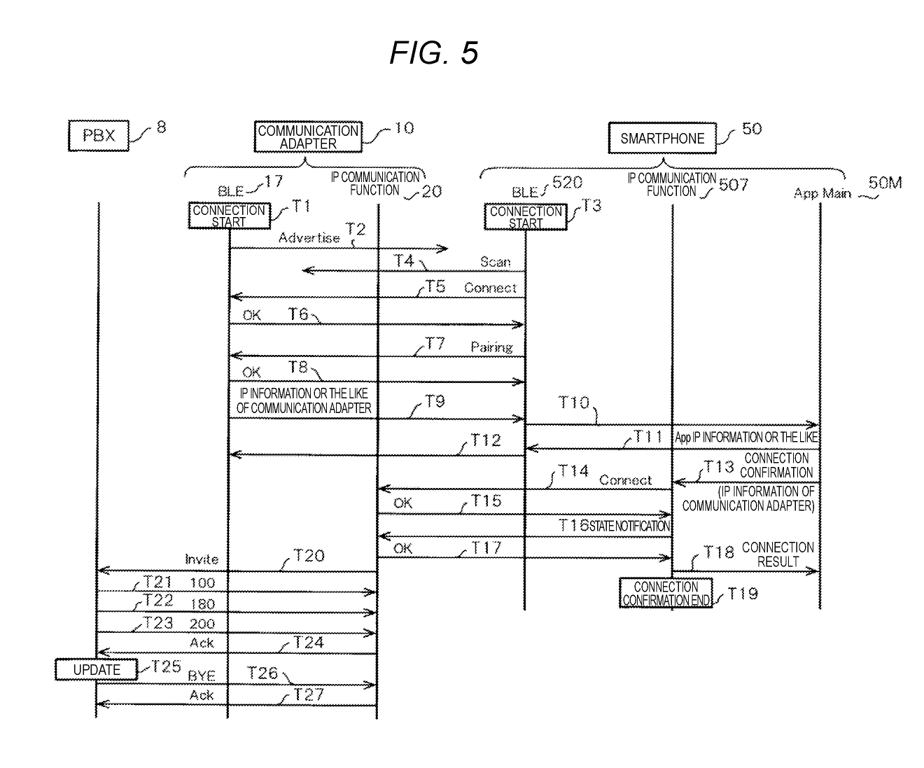

FIG. 5 is a sequence diagram showing an initial connection operation between communication adapter 10 and smartphone 50.

In the sequence diagrams of the accompanying drawings herein, reference numeral 507 attached to the IP communication function of smartphone 50 corresponds to IP communication controller 507 of FIG. 4, and reference numeral 520 attached to the BLE of smartphone 50 corresponds to BLE module 520 of FIG. 4. Similarly, reference numeral 20 attached to the IP communication function of communication adapter 10 corresponds to network I/F 20 of FIG. 3, and reference numeral 14 attached to the BLE of communication adapter 10 corresponds to BLE processor 14 of FIG. 3. In the description of the sequence diagrams of the accompanying drawings herein, operations (processes) of IP communication controller 507 and BLE module 520 in smartphone 50 are performed based on instructions about execution control from controller 506. Similarly, in the description of the sequence diagrams of the accompanying drawings herein, the operations (processes) of network I/F 20 and BLE processor 14 in communication adapter 10 are performed based on instructions about execution control from CPU 11.

In FIG. 5, communication adapter 10 starts the connection with smartphone 50 by BLE processor 14 (T1), by soft keys k11, k12, and k13 or the setting menu being operated by the user. At the start of this connection, BLE processor 14 broadcasts Advertise information to smartphone 50 to indicate the presence of communication adapter 10 (T2).

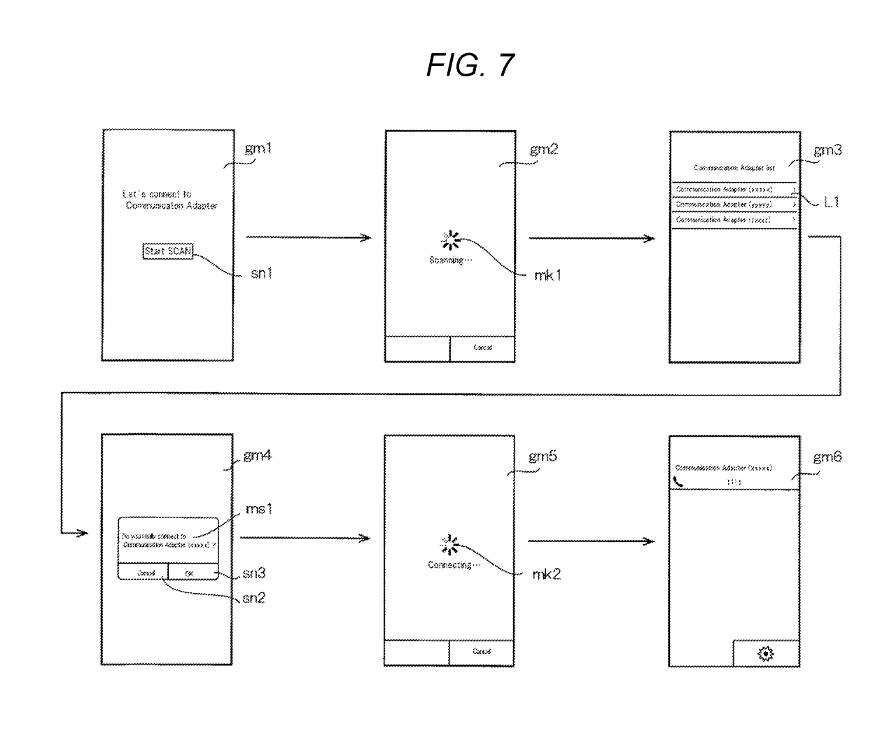

On the other hand, when the user presses connection start button sn1 (see FIG. 7) on touch panel 503, smartphone 50 starts connection by BLE module 520 (T3). At the start of this connection, BLE module 520 scans and checks the presence or absence of communication adapter 10 that has distributed the Advertise information (T4). As a result of the checking by scanning, when communication adapter 10 that has distributed the Advertise information is found, BLE module 520 transmits a Connect command requesting the connection with found communication adapter 10, to BLE processor 14 (T5).

In response to the connection request from BLE module 520, BLE processor 14 returns an OK command indicating a response (T6).

BLE module 520 transmits a Pairing command requesting pairing connection capable of mutual communication, to BLE processor 14 (T7). When receiving the Pairing command, BLE processor 14 returns an OK command indicating a response (that is, a processing result of the interconnection) to the pairing connection request (T8). Thus, the pairing connection between communication adapter 10 and smartphone 50 by the BLE communication is performed.

When the pairing connection by the BLE communication is performed, BLE processor 14 transmits the IP information and the like (including the IP address and the port number, for example) of communication adapter 10 to BLE module 520 (T9). The IP information is used to exchange information for performing the IP communication between the IP communication function (that is, network IT 20) of communication adapter 10 and the IP communication function (that is, IP communication controller 507) of smartphone 50, and is to perform switching from the standby mode in which the power consumption of smartphone 60 is suppressed to the active mode in which the power consumption of smartphone 60 is not suppressed, by BLE communication. That is, the transition from the standby mode to the active mode is triggered by BLE communication.

When receiving the IP information or the like of communication adapter 10 from BLE processor 14, BLE module 520 transfers the IP information or the like of the communication adapter to application 50M being executed in smartphone 50 (T10). Application 50M can be read and executed by controller 506 of smartphone 50 from storage 504. Upon receiving the IP information or the like of communication adapter 10, application 50M transfers the IP information or the like of smartphone 50 to BLE module 520 (T11). BLE module 520 transmits the IP information or the like of smartphone 50 to BLE processor 14 (T12).

Communication adapter 10 and smartphone 50 start connection by IP communication by using the IP information or the like obtained by executing the procedures T1 to T12 described above. When application 50M transfers the IP information of communication adapter 10 to the IP communication function (that is, IP communication controller 507) (T13), the IP communication function (that is, IP communication controller 507) transmits a

Connect command requesting IP communication connection to the IP communication function (that is, network I/F 20) of communication adapter 10 (T14).

Upon receiving the IP communication connection request, the IP communication function (that is, network I/F 20) returns an OK command indicating a response to the IP communication function (that is, IP communication controller 507) (T15).

The IP communication function (that is, IP communication controller 507) transmits the state of smartphone 50 to the IP communication function (that is, network I/F 20) (T16). The IP communication function (that is, network I/F 20) returns an OK command indicating a response to the IP communication function (that is, IP communication controller 507) (T17). The IP communication function (that is, IP communication controller 507) transfers the connection result to application 50M (T18). Thereafter, the IP communication function (that is, IP communication controller 507) ends confirming the connection between communication adapter 10 and smartphone 50 (T19). IP communication between communication adapter 10 and smartphone 50 is confirmed in procedures T14 to T19 described above. If the confirmation of the IP communication connection is ended, smartphone 50 shifts from the active mode to the standby mode.

Subsequently, a description is made about the operation in which communication adapter 10 makes a call with PBX 8 to the special number using a session initiation protocol (SIP). The special number is generally a number for using the functions (extensions, external lines, transfer, or the like) of the PBX, and here, it represents a number for notifying that the user of communication adapter 10 is present. The IP communication function (that is, network I/F 20) transmits to PBX 8, an Invite command requesting a special number indicating a notification of presence (T20). Upon receiving the Invite command, PBX 8 transmits a “100” command indicating a response to the IP communication function (that is, network I/F 20) (T21). PBX 8 transmits a “180” command indicating ringing (T22), and subsequently transmits a “200” command indicating success (T23). Upon receiving these commands, the IP communication function (that is, network I/F 20) returns an Ack command indicating confirmation of session connection to PBX 8 (T24). When receiving call to a special number from the IP communication function (that is, network I/F 20), PBX 8 determines that the user is present at the desk at which communication adapter 10 is installed, changes the presence state of the user to “Presence”, and updates presence server 8z (T25).

After changing the presence state of communication adapter 10, PBX 8 transmits a BYE command indicating session disconnection to the IP communication function (that is, network I/F 20) (T26). The IP communication function (that is, network I/F 20) returns the Ack command indicating confirmation of session disconnection to PBX 8 (T27).

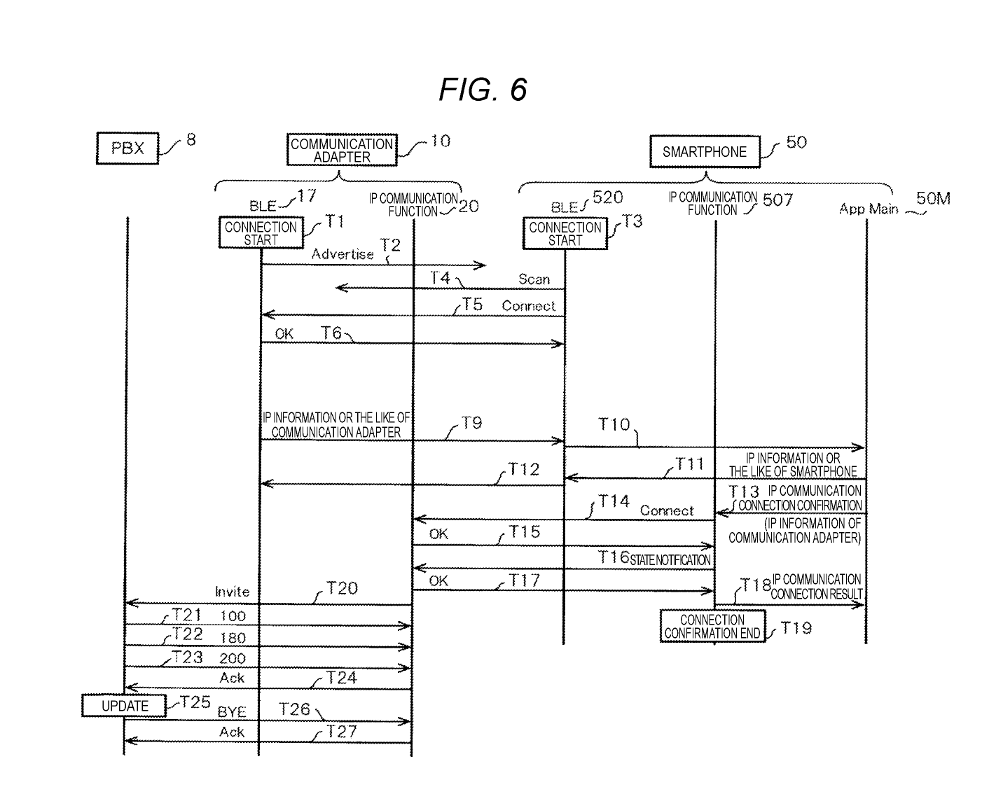

FIG. 6 is a sequence diagram showing second and subsequent connection operations between communication adapter 10 and smartphone 50.

Since the pairing between communication adapter 10 and smartphone 50 has already been completed in the second and subsequent connection operations, the processes of procedures T7 and T8 in FIG. 5 are omitted. That is, in FIG. 6, BLE module 520 immediately transmits a Connect command requesting connection to BLE processor 14 of communication adapter 10 found as a result of the scanning of procedure T4 (T5). In response to the connection request from BLE module 520, BLE processor 14 returns an OK command indicating a response (T6). Thereafter, in the same manner as the initial connection operation, the connection procedure of the IP communication between communication adapter 10 and smartphone 50 is started.

As described above, since the pairing connection operation is omitted in the second and subsequent connection operations, time to connection can be shortened.

In addition, when the user leaves the seat with smartphone 50 (that is, the user is absent), the BLE communication link between smartphone 50 and communication adapter 10 is disconnected (that is, it is interrupted), or when the user presses a disconnection key (not shown) of smartphone 50, a disconnection operation between smartphone 50 and communication adapter 10 is performed. FIG. 7 is a diagram showing a screen transition of smartphone 50 when starting IP communication connection with the communication adapter 10.

First, smartphone 50 displays scanning start screen gm1 on touch panel 503. Connection start button sn1 is displayed on scan start screen gm1. When connection start button sn1 is pressed, smartphone 50 displays scanning screen gm2 indicating that scanning is in progress, on touch panel 503. Wait mark mk1 is displayed to move until communication adapter 10 as a communication partner is found, on scanning screen gm2.

When scanning is completed, smartphone 50 displays scanning result screen gm3 on touch panel 503. List L1 of communication adapters 10 found by scanning is displayed on scanning result screen gm3. Here, three communication adapters 10 are displayed as a scanning result. When the user presses and selects the display position of communication adapter 10 registered in list L1, smartphone 50 displays connection confirmation screen gm4 on touch panel 503. Message ms1 indicating whether or not connection with communication adapter 10 is ready, cancel button sn2, and permission (OK) button sn3 are displayed on connection confirmation screen gm4.

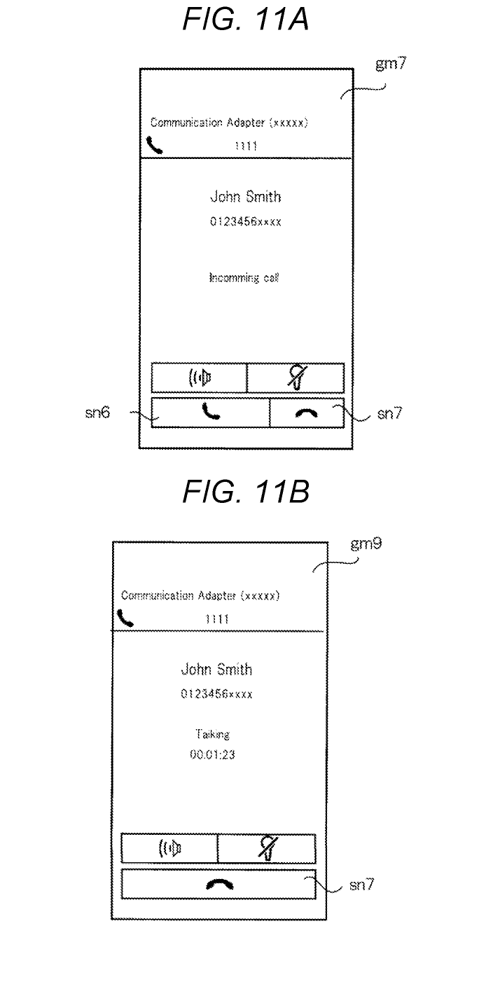

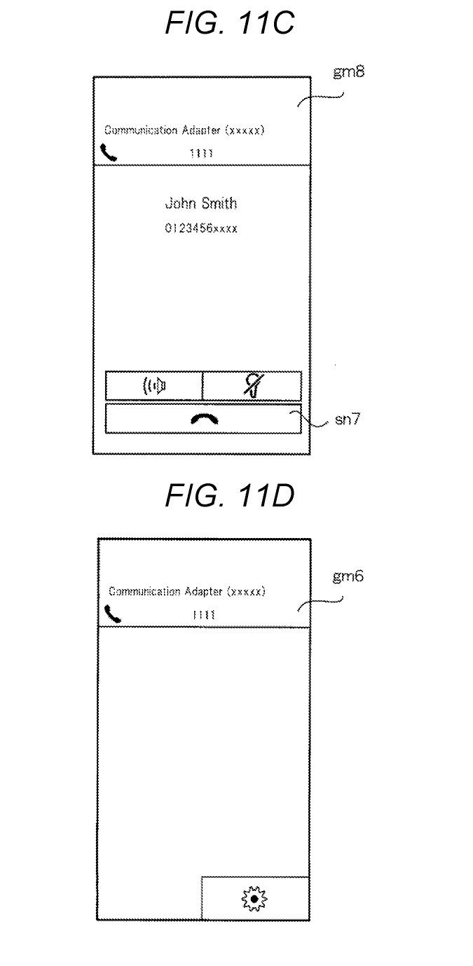

When the user presses OK button sn3, smartphone 50 displays connecting screen gm5 on touch panel 503. Message ms2 of “connecting” indicating connecting is displayed on connecting screen gm5. When the connection is completed, smartphone 50 displays idle screen gm6 (see FIG. 11D) on touch panel 503. In the order described above, the screen transition of smartphone 50 at the start of the IP communication connection is completed.

As described above, communication system 5 according to Exemplary Embodiment 1 includes PBX (telephone exchange) 8, smartphone 50 (telephone communication terminal), and communication adapter 10 that transmits and receives a signal about the call between PBX 8 and smartphone 50. Upon detecting an event related to the connection with smartphone 50, communication adapter 10 performs a process (for example, a pairing) for interconnection with smartphone 50, between communication adapter 10 and smartphone 50, by using the BLE communication (an example of the first communication). After performing the process for interconnection with communication adapter 10, smartphone 50 transmits information on smartphone 50, to communication adapter 10 by using IP communication (an example of the second communication). Communication adapter 10 makes a call to a special number (for example, transmission of the signal of the Invite command) to PBX 8, as a notification to PBX 8 that the user of smartphone 50 capable of IP communication with communication adapter 10 is present, based on the process for interconnection using BLE communication (first communication) and IP information (an example of information on a telephone communication terminal) of smartphone 50, which is transmitted from smartphone 50 by IP communication (second communication).

Thus, in a case where an incoming call comes from the telephone of a call partner and is transferred to the telephone of a different person, communication system 5 quickly checks whether the different person is present or not, and can efficiently support the transfer of the incoming call to the telephone of the different person, as necessary.

Smartphone 50 and communication adapter 10 are provided for each user.

PBX 8 includes presence server 8z that stores a table (an example of a memory) that retains information indicating the presence or absence of smartphone 50 using IP communication with communication adapter 10, for each of communication adapters 10 connected to PBX 8. PBX 8 updates the table stored in presence server 8z, based on the Invite signal indicating the notification that the user of smartphone 50 capable of IP communication is present, transmitted from at least one communication adapter 10. Thus, PBX 8 can centrally manage the presence status of each of a plurality of users who possess the telephone communication terminals.

Further, communication adapter 10 makes a notification of the presence of smartphone 50 which has completed the pairing connection (interconnection) process by using the BLE communication. Thus, the user can check the presence state of the user, and can wait in a state waiting for incoming call or in a state of being able to make a call.

Communication adapter 10 includes a plurality of BLF keys k1 to k10 in which BLF key LED 18 (an example of a light emitting unit) for indicating the presence of smartphone 50 is disposed, for each smartphone 50.

Communication adapter 10 registers the number of smartphone 5 corresponding to each of the plurality of LF keys k1 to k10 in flash memory 13 (an example of the second memory), thereby displaying the state of corresponding smartphone 50 based on the information from PBX 8. Thus, the user can easily know the presence state of the user and other users possessing other smartphones, and perform the event related to the connection with the smartphone of the user who is present by a one-touch operation.

### Background to Achieve the Contents of Exemplary Embodiment 2

In the above-mentioned Japanese Unexamined Patent Application Publication No. 2014-239296, it is disclosed that a smartphone possessed by a user can be registered and used as a cordless slave device for a cordless master device in a house. However, according to the related art as disclosed in Japanese Patent Unexamined Publication No. 2014-239296, it is not assumed that the smartphone possessed by the user is used, for example, as a business cordless telephone which can be connected to a telephone exchange installed in a company or the like.

Therefore, for example, when an event (for example, an incoming call or an outgoing call) related to a call occurs on a business basis, a user (that is, an employee) is required to pick up his or her smartphone and perform necessary operations one by one according to the contents of the event related to the call. However, this may lead to a decrease in operational efficiency in such a manner that sometimes operability using his or her smartphone is not good at work and at least some of his or her work may be stagnant, even for a user who is unfamiliar with such an operation.

Therefore, in Exemplary Embodiment 2, a description will be made about examples of a communication system, a communication method, and a communication adapter which suppress deterioration in operability when a user's smartphone is used as a cordless telephone in business, and can support improvement of operational efficiency, even for a user who is unfamiliar with a necessary operation according to the content of an event related to a call.

### Exemplary Embodiment 2

Since the configuration of communication system 5 in Exemplary Embodiment 2 is the same as that in Exemplary Embodiment 1, the same reference numerals are used, and description thereof will be omitted.

### Incoming Call Operation

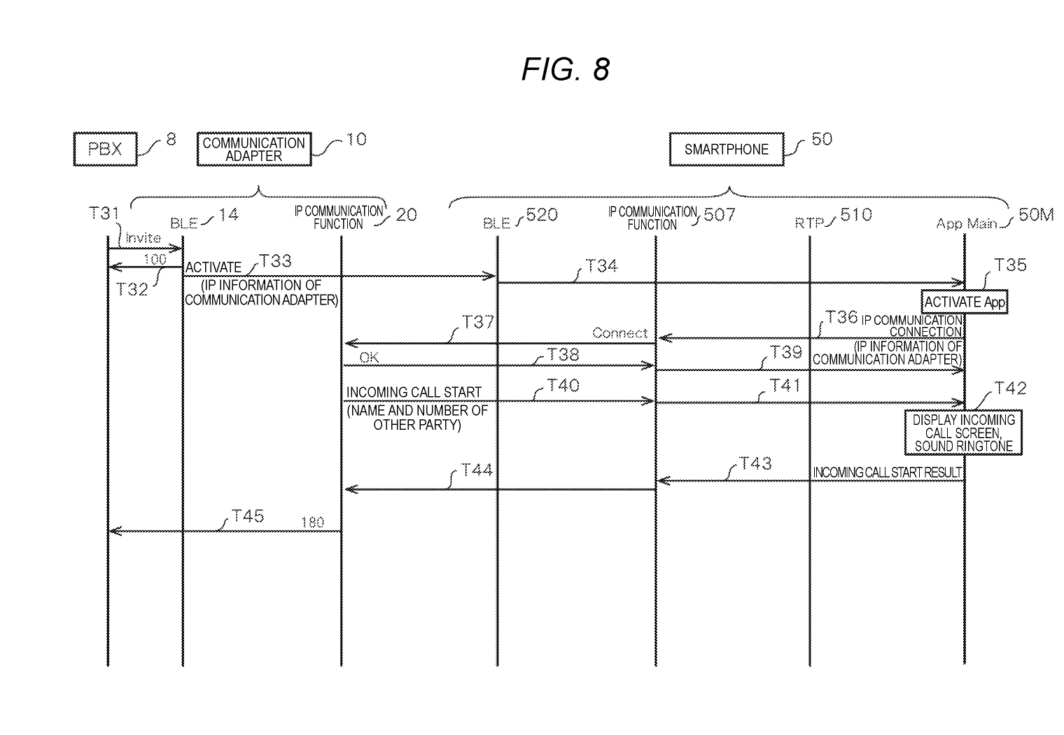

FIG. 8 is a sequence diagram showing an incoming call operation procedure in a case where communication adapter 10 makes an incoming call response.

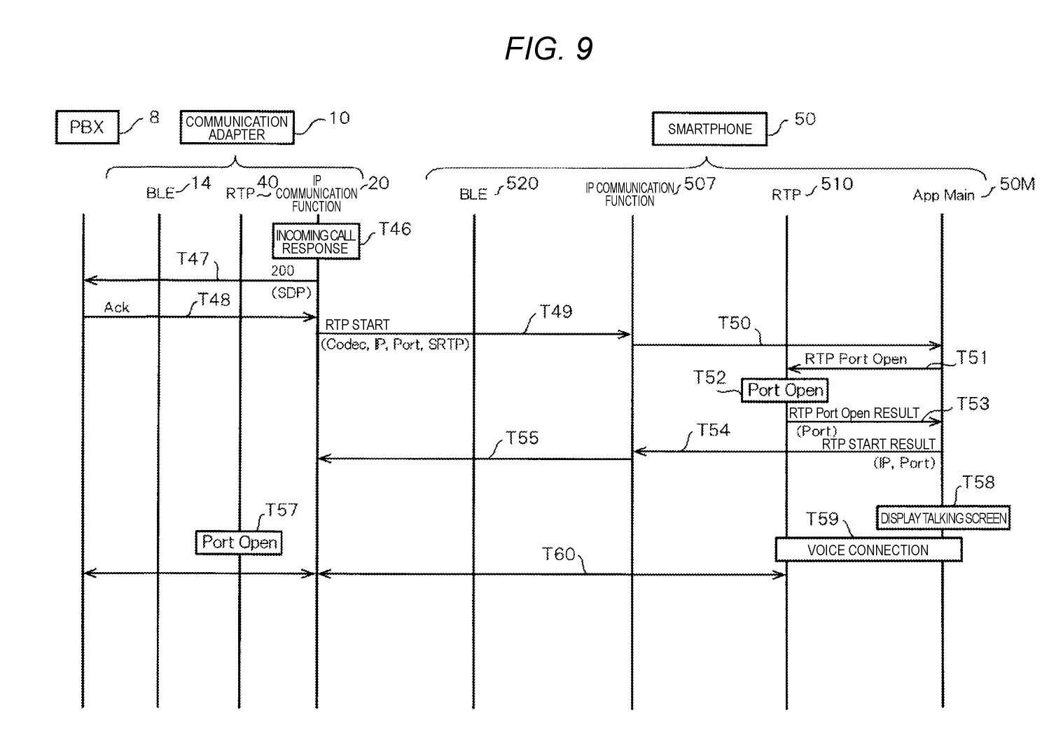

FIG. 9 is a sequence diagram showing an incoming call operation procedure in a case where the communication adapter makes an incoming call response subsequent to FIG. 8.

In the sequence diagrams of the accompanying drawings herein, the reference numeral 40 attached to the RTP of communication adapter 10 corresponds to CPU 11 of FIG. 3, and reference numeral 510 attached to the RTP of smartphone 50 corresponds to controller 506 of FIG. 4.

Before the incoming call operation, smartphone 50 operates in the standby mode with reduced power consumption. In FIG. 8, when receiving the Invite command to transfer the incoming from PBX 8 (T31), the IP communication function (that is, network I/F 20) of communication adapter 10 returns a “100” command indicating the incoming call response to PBX 8 (T32). BLE processor 14 transmits the IP information on communication adapter 10, to BLE module 520 of smartphone 50 (T33). The IP information is data (signal) for shifting smartphone 50 from the standby mode to the active mode.

Upon receiving the IP information on the communication adapter, BLE module 520 transfers the IP information to application 50M (T34). Upon receiving the IP information on the communication adapter, application 50M is activated to cause smartphone 50 to be shifted from the standby mode to the active mode (T35). Application 50M instructs the IP communication function (that is, IP communication controller 507) to perform IP communication connection by using the IP information of the communication adapter (T36). The IP communication function (that is, IP communication controller 507) transmits a Connect command requesting IP communication connection, to the IP communication function (that is, network I/F 20) of communication adapter 10 (T37). The IP communication function (that is, network I/F 20) returns an OK command indicating a response to the communication function (that is, IP communication controller 507) (T38). The IP communication function (that is, IP communication controller 507) transfers the OK command to application 50M (T39).

The IP communication function (that is, network I/F 20) transmits an incoming call start instruction, to the IP communication function (that is, IP communication controller 507) (T40). In the incoming call start, the IP communication function (that is, network I/F 20) notifies the IP communication function (that is, IP communication controller 507) of the name and number of the other party connected to PBX 8. The IP communication function (that is,

IP communication controller 507) transfers the name and number of the other party, to application 50M (T41).

Upon receiving an incoming call from communication adapter 10 on idle screen gm6, application 50M displays incoming screen gm7 on touch panel 503 of smartphone 50, and causes speaker 513 to sound a ringtone (T42).

FIG. 11A is a diagram showing incoming call screen gm7.

An incoming call indication “Incoming CALL”, call start button sn6, call end button sn7, and the like are displayed on incoming call screen gm7.

Application 50M returns the fact that the incoming call is started, to the IP communication function (that is, IP communication controller 507) (T43). The IP communication function (that is, IP communication controller 507) returns the fact that the incoming call is started, to the IP communication function (that is, IP communication controller 507) of communication adapter 10 (T44). The IP communication function (that is, network I/F 20) returns a “180” command indicating that smartphone 50 has sounded, to PBX 8 (T45).

When the user presses CALL button bn1 of communication adapter 10 to answer an incoming call, the IP communication function (that is, network I/F 20) transmits a “200” command indicating that the incoming call has been answered, to PBX 8 (T47). The SDP of the “200” command includes information such as a protocol used for a call. Upon receiving the “200” command, PBX 8 returns an Ack indicating a response, to the IP communication function (that is, network I/F 20) (T48).

The IP communication function (that is, network I/F 20) transmits a Real time Transports Protocol (RTP) start instruction, to the IP communication function (that is, IP communication controller 507) (T49). In smartphone 50, at the start of RTP, IP communication function (that is, IP communication controller 507) transfers an RTP start instruction to application 50M (T50).

Upon receiving the RTP start instruction, application 50M requests RTP 510 (that is, controller 506) to release the port (T51). RTP 510 (that is, controller 506) is executed in controller 506. In response to this request, RTP 510 (that is, controller 506) releases the port (T52), and returns the release result to application 50M (T53). Application 50M transmits the result of the

RTP start to the IP communication function (that is, IP communication controller 507) (T54). The result of the RTP start includes the IP address and port number of smartphone 50.

The IP communication function (that is, IP communication controller 507) returns the result of the RTP start to the IP communication function (that is, network I/F 20) (T55). RTP 40 (that is, CPU 11) releases the port (T57).

Application 50M displays talking screen gm9 (T58).

FIG. 11B is a diagram showing talking screen gm9.

The name and number of a call partner, “Talking” indicating talking, the duration of call, call end button sn7, or the like are displayed on talking screen gm9. Application 50M makes a voice connection with RTP 510 (that is, controller 506) (T59). When RTP 40 (that is, CPU 11) and RTP 510 (that is, controller 506) are connected by the RTP communication, communication adapter 10 relays the voice data transferred between the call partner connected to PBX 8 and smartphone 50 (T60).

Subsequently, an incoming call operation in a case where smartphone 50 makes an incoming call response will be described.

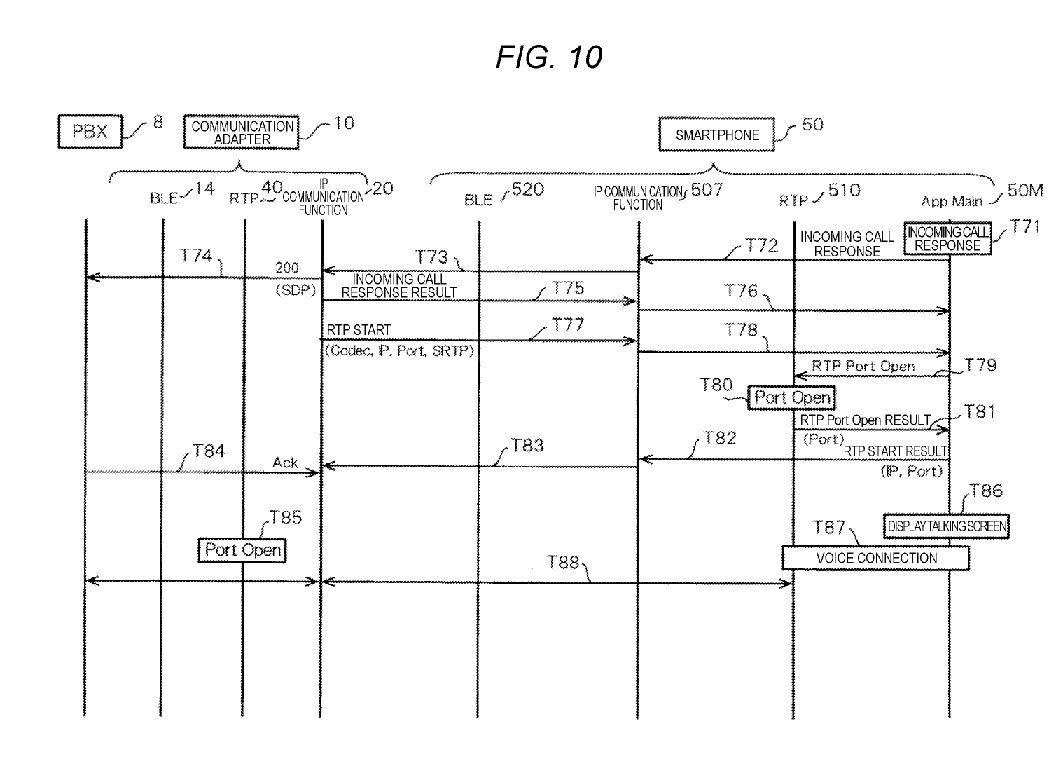

FIG. 10 is a sequence diagram showing an incoming call operation procedure in a case where smartphone 50 makes an incoming call response.

The operations of the procedures T31 to T45 described above are also the same in the case where smartphone 50 makes an incoming call response.

Upon receiving an incoming call response by a user operation (T71), application 50M transmits the incoming response to the IP communication function (that is, IP communication controller 507) (T72). The IP communication function (that is, IP communication controller 507) transfers the incoming response to the IP communication function (that is, network I/F 20) (T73). The IP communication function (that is, network I/F 20) transmits a “200” command indicating that smartphone 50 has answered an incoming call, to PBX 8 (T74).

The IP communication function (that is, network I/F 20) transmits the result of the incoming call response to the IP communication function (that is, IP communication controller 507) (T75). The IP communication function (that is, IP communication controller 507) transfers the result of the incoming call response to application 50M (T76).

The IP communication function (that is, network I/F 20) transmits the RTP start instruction and additional information (a codec, an IP address, a port number, a Secure Real Time Transport Protocol (SRTP)) to the IP communication function (that is, IP communication controller 507) (T77). The IP communication function (that is, IP communication controller 507) transfers the RTP start and additional information to application 50M (T78).

Application 50M instructs RTP 510 (that is, controller 506) to release the port (T79). In response to the instruction, RTP 510 (that is, controller 506) releases the port (T80), and returns the release result to application 50M (T81). Application 50M transmits the result of the RTP start to the IP communication function (that is, IP communication controller 507) (T82). The result of the RTP start includes the IP address and port number of smartphone 50.

The IP communication function (that is, IP communication controller 507) transfers the result of the RTP start to the IP communication function (that is, network I/F 20) (T83). In addition, the IP communication function (that is, network I/F 20) receives the Ack from PBX 8 as a response to the command “200” of procedure T74 (T84), and thus RTP 40 (that is, CPU 11) releases the port (T85).

Application 50M displays above-described talking screen gm9 (T86). Application 50M makes a voice connection with RTP 510 (that is, controller 506) (T87). When RTP 40 (that is, CPU 11) and RTP 510 (that is, controller 506) are connected, communication adapter 10 relays the voice data transferred between the call partner connected to PBX 8 and smartphone 50 (T88).

### Outgoing Call Operation

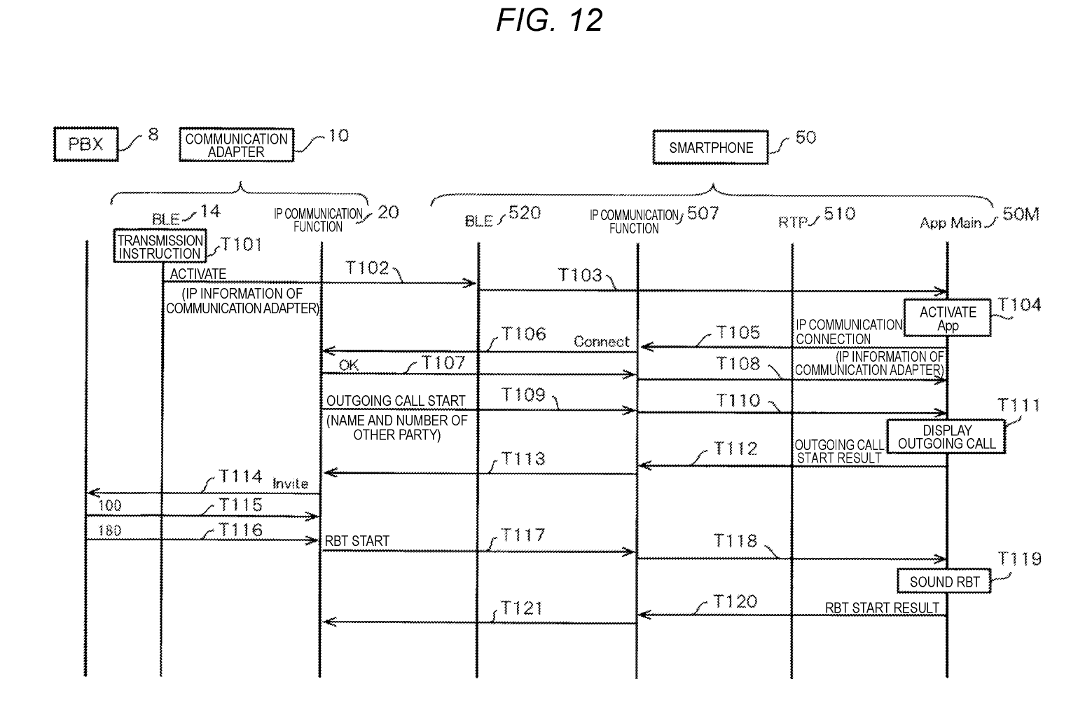

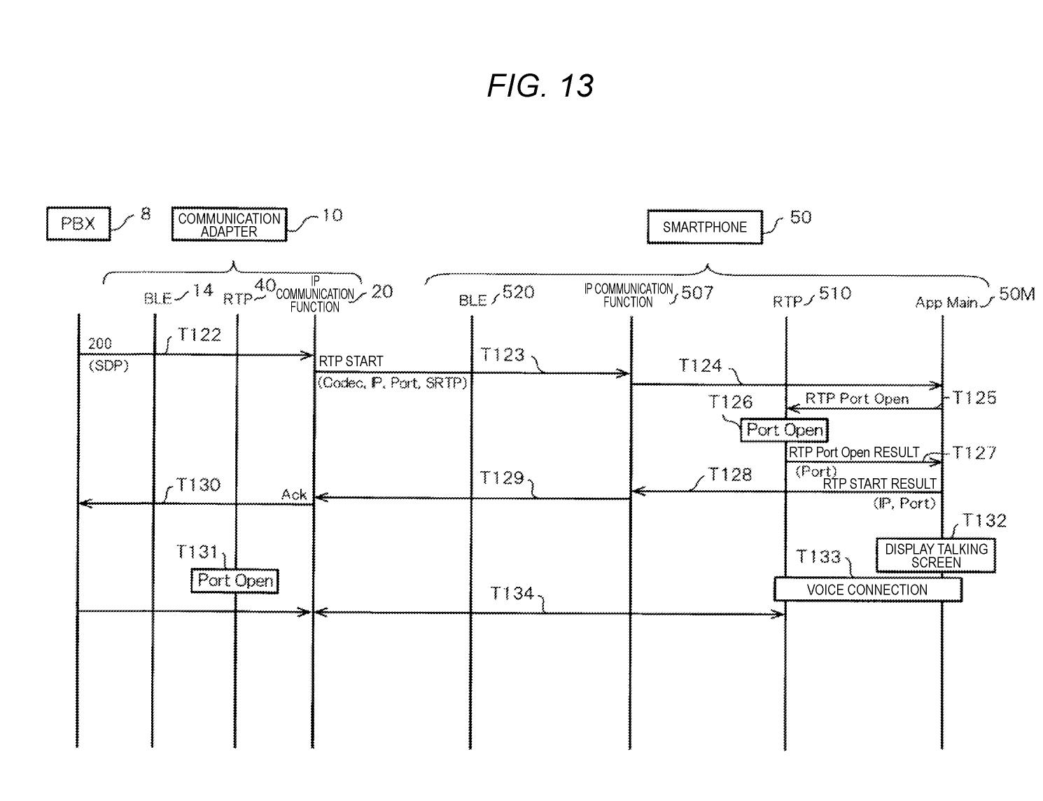

FIG. 12 is a sequence diagram showing an outgoing call operation procedure. FIG. 13 is a sequence diagram showing an outgoing call operation procedure subsequent to FIG. 12.

Before the outgoing call operation, smartphone 50 operates in the standby mode with reduced power consumption. In FIG. 12, when the user presses 12-key 17 to input the number and presses CALL button bn1 on communication adapter 10, BLE processor 14 issues an outgoing call instruction (T101). In a case where the destination number is registered in the BLF key, the BLF key may be pressed instead of the 12-key, so that a call can be made by a one-touch operation. BLE processor 14 transmits the IP information on communication adapter 10 to smartphone 50 (T102).

Upon receiving the IP information on communication adapter 10 from BLE processor 14, BLE module 520 of smartphone 50 transfers the IP information to application 50M (T103). Application 50M is activated to cause smartphone 50 to be shifted from the standby mode to the active mode (T104). Application 50M notifies the IP communication function (that is, IP communication controller 507) of the IP information on communication adapter 10 to instruct it to make an IP communication connection (T105).

The IP communication function (that is, IP communication controller 507) transmits a Connect command to the IP communication function (that is, network I/F 20) of communication adapter 10 to make a connection (T106). The IP communication function (that is, network I/F 20) returns an OK command indicating permission of connection to the IP communication function (that is, IP communication controller 507) (T107). Upon receiving the OK command, the IP communication function (that is, IP communication controller 507) transfers the OK command to application 50M (T108). Subsequently, the IP communication function (that is, network I/F 20) transmits an outgoing call start instruction (including the name and number of the other party) to the IP communication function (that is, IP communication controller 507) (T109).

Upon receiving the outgoing call start instruction (including the name and number of the other party), the IP communication function (that is, IP communication controller 507) transfers the outgoing call start to application 50M (T110).

Application 50M displays outgoing call screen gm8 on touch panel 503.

FIG. 11C is a diagram showing outgoing call screen gm8.

The name and number of the call partner, call end button sn7, or the like are displayed on outgoing call screen gm8.

Application 50M returns the result of the outgoing call start to IP communication function 507 (T112).

IP communication function 507 transmits the result of the outgoing call start to the IP communication function (that is, network I/F 20) (T113). The IP communication function (that is, network I/F 20) transmits an Invite command indicating that a call is made, to PBX 8 (T114). PBX 8 returns a “100” command indicating a telephone answering, to the IP communication function (that is, network I/F 20) (T115). PBX 8 transmits a “180” command indicating that the telephone of the other party is ringing, to the IP communication function (that is, network I/F 20) (T116).

The IP communication function (that is, network I/F 20) transmits a ring back tone (RBT: ringing tone) start instruction to the IP communication function (that is, IP communication controller 507) of smartphone 50 (T117). The IP communication function (that is, IP communication controller 507) transfers the RBT start instruction to application 50M (T118). Upon receiving the RBT start instruction, application 50M sounds a ringtone from speaker 513 (T119). Application 50M returns the result of the RBT start to the IP communication function (that is, IP communication controller 507) (T120). The IP communication function (that is, IP communication controller 507) transmits the result of the RBT start to the IP communication function (that is, network I/F 20) (T121).

When receiving from PBX 8 (T122), “200” command (including SDP) indicating that a recipient party responds the call (answers the phone), the IP communication function (that is, network I/F 20) transmits the RTP start instruction to the IP communication function (that is, IP communication controller 507) (T123). The RTP start includes additional information (a codec, an IP address, a port number, and SRTP).

The IP communication function (that is, IP communication controller 507) transfers the RTP start instruction to application 50M (T124). Upon receiving the RTP start instruction, application 50M instructs RTP 510 (that is, controller 506) to release the port (T125). In response to the instruction, RTP 510 (that is, controller 506) releases the port (T126), and returns the release result to application 50M (T127). Application 50M transmits the result of the RTP start to the IP communication function (that is, IP communication controller 507) (T128). The result of the RTP start includes an IP address and a port number. The IP communication function (that is, IP communication controller 507) transmits the result of the RTP start to the IP communication function (that is, network I/F 20) (T129). The IP communication function (that is, network I/F 20) returns an Ack command indicating that synchronization with smartphone 50 is established as a response of the “200” command in procedure T122 (T130). RTP 40 (that is, CPU 11) releases the port (T131).

Application 50M displays talking screen gm9 described above (see FIG. 11B) on touch panel 503 (T132). Application 50M makes a voice connection with RTP 510 (that is, controller 506) (T133). Thereafter, communication adapter 10 relays the voice data transferred between communication adapter 10 and smartphone 50 (T134).

### Call Transfer

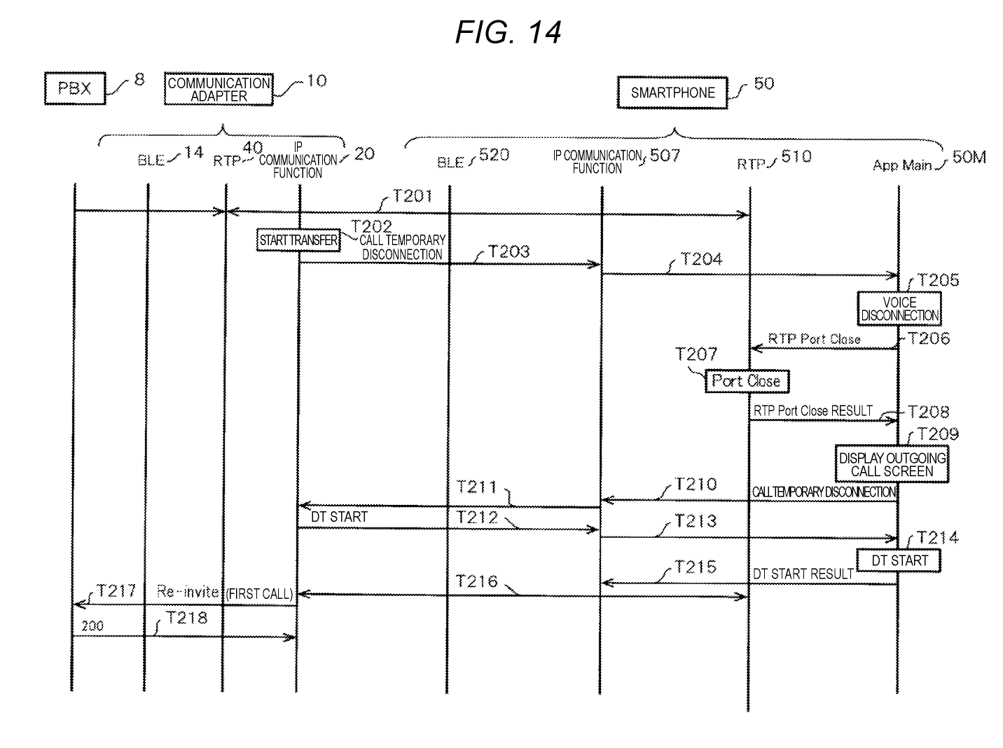

FIG. 14 is a sequence diagram showing a call transfer operation.

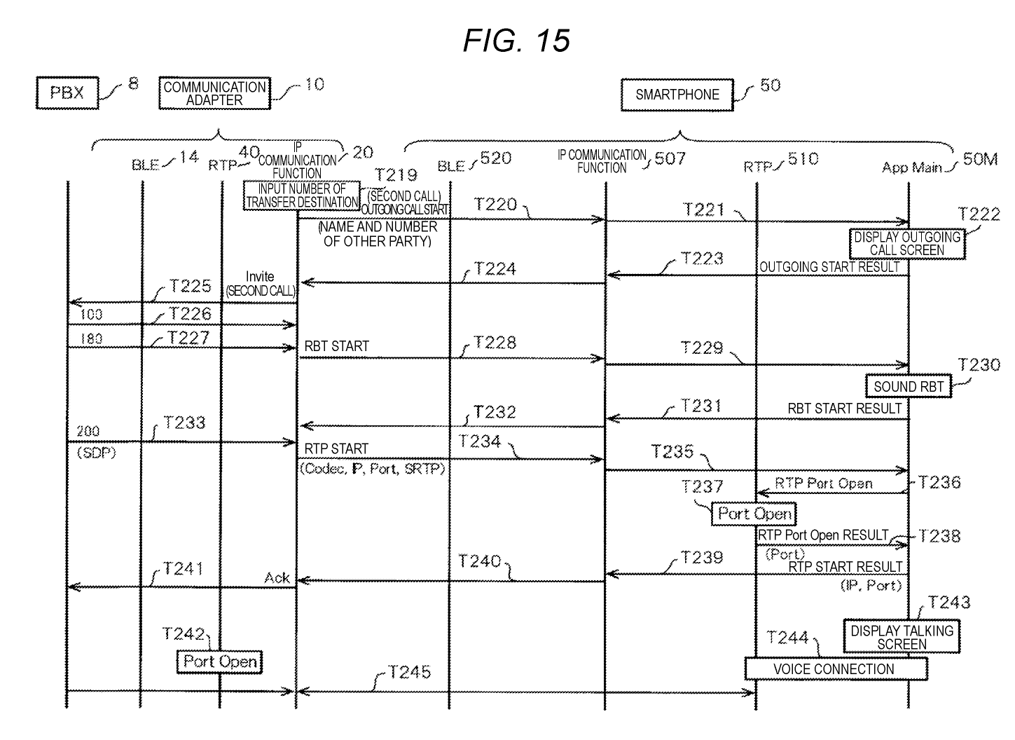

FIG. 15 is a sequence diagram showing a call transfer operation subsequent to FIG. 14.

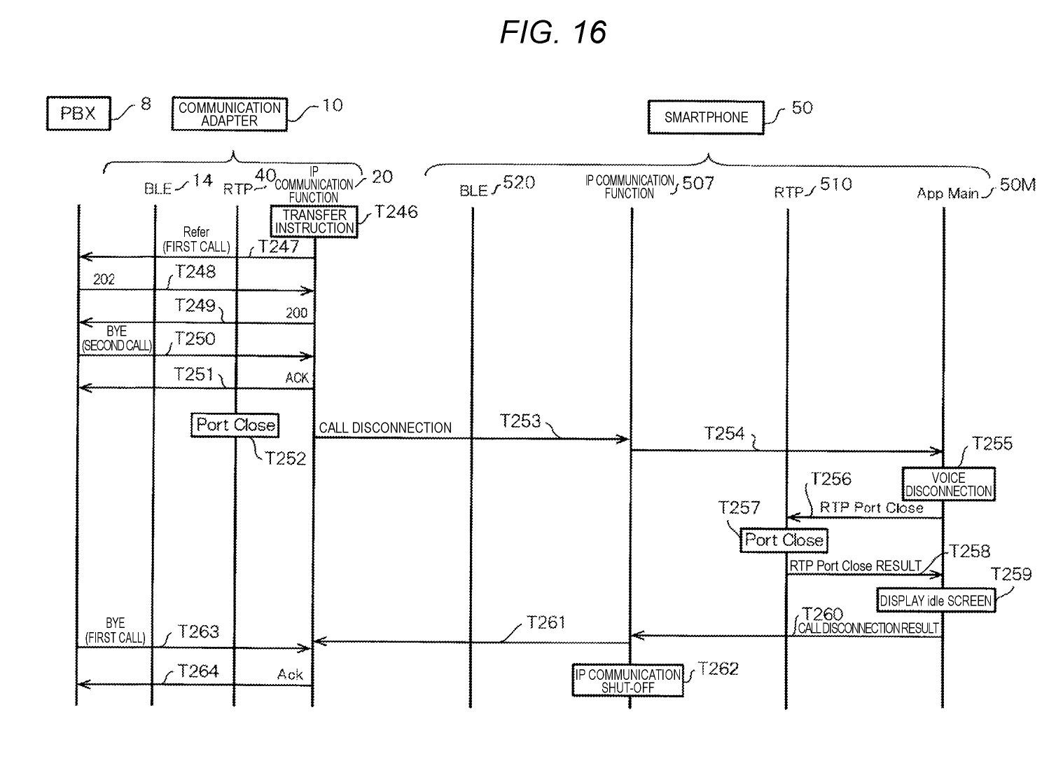

FIG. 16 is a sequence diagram showing a call transfer operation subsequent to FIG. 14 and FIG. 15.

In FIG. 14, when the user presses TRANSFER button bn2 of communication adapter 10 and instructs to transfer a call, during a call between a telephone (telephone communication terminal) of a call destination connected to PBX 8 and smartphone 50 (T201), the IP communication function (that is, network I/F 20) of communication adapter 10 starts transferring (T202).

The IP communication function (that is, network I/F 20) transmits call temporary disconnection to the IP communication function (that is, IP communication controller 507) of smartphone 50 (T203). The IP communication function (that is, IP communication controller 507) transfers the call temporary disconnection to application 50M (T204). Upon receiving the call temporary disconnection instruction, application 50M disconnects the voice (T205). Application 50M instructs RTP 510 (that is, controller 506) to close the port (T206). In response to the instruction, RTP 510 (that is, controller 506) closes the port (T207), and returns the closing result to application 50M (T208). Application 50M switches the display from talking screen gm9 (see FIG. 11B) to outgoing call screen gm8 (see FIG. 11C) (T209). Application 50M transmits the call temporary disconnection result to the IP communication function (that is, IP communication controller 507) (T210). The IP communication function (that is, IP communication controller 507) transmits the temporary call disconnection result to the IP communication function (that is, network I/F 20) (T211).

Upon receiving the call temporary disconnection result, the IP communication function (that is, network I/F 20) transmits a dial tone (DT) start instruction to the IP communication function (that is, IP communication controller 507) (T212). The IP communication function (that is, IP communication controller 507) transfers the DT start instruction to application 50M (T213). Upon receiving the DT start instruction, application 50M starts sounding a dial tone (T214). Application 50M returns the result of the DT start to the IP communication function (that is, IP communication controller 507) (T215). The IP communication function (that is, IP communication controller 507) transmits the result of the DT start to the IP communication function (that is, network I/F 20) (T216).

The IP communication function (that is, network I/F 20) transmits a Re-Invite command to hold the call (first call) with PBX 8 side once, to PBX 8 (T217). PBX 8 returns a “200” command indicating acceptance of the call temporary hold to the IP communication function (that is, network I/F 20) (T218) once.

When the user presses 12-key 17 to input the number of the transfer destination (second call) and presses CALL button bn1 on communication adapter 10, the IP communication function (that is, network I/F 20) issues an outgoing call instruction (T219). In a case where the transfer destination number is registered in the BLF key, the BLF key may be pressed instead of the 12-key, so that a call can be made by a one-touch operation. The IP communication function (that is, network I/F 20) transmits an outgoing call start instruction of a second call, to the IP communication function (that is, IP communication controller 507) (T220). The IP communication function (that is, IP communication controller 507) transfers the outgoing call start instruction of a second call, to application 50M (T221). The outgoing call start instruction of a second call includes the name and number of the call partner. Application 50M displays outgoing call screen gm8 (see FIG. 11C) described above (T222).

Application 50M returns the result of the outgoing call start to the IP communication function (that is, IP communication controller 507) (T223). The IP communication function (that is, IP communication controller 507) transmits the result of the outgoing call start to the IP communication function (that is, network I/F 20) (T224). When receiving the result of the outgoing call start, the IP communication function (that is, network I/F 20) transmits an Invite command indicating that a telephone call (second call) has been made to PBX 8 (T225).

PBX 8 returns a “100” command indicating that a telephone call is received (answered), to the IP communication function (that is, network I/F 20) (T226). PBX 8 transmits a “180” command indicating that the telephone of the other party is ringing, to the IP communication function (that is, network I/F 20) (T227). The IP communication function (that is, network I/F 20) transmits a ring back tone (RBT: ringtone) start to the IP communication function (that is, IP communication controller 507) of smartphone 50 (T228). The IP communication function (that is, IP communication controller 507) transfers the RBT start instruction to application 50M (T229). Upon receiving the RBT start instruction, application 50M sounds a ringtone from speaker 513 (T230). Application 50M returns the result of the RBT start to the IP communication function (that is, IP communication controller 507) (T231). The IP communication function (that is, IP communication controller 507) transmits the result of the RBT start to the IP communication function (that is, network I/F 20) (T232).

PBX 8 transmits a “200” command (including SDP) indicating that the call partner of the transfer destination has answered the telephone, to the IP communication function (that is, network I/F 20) (T233). The IP communication function (that is, network I/F 20) transmits the RTP start instruction indicating the start of a call with the transfer destination, to the IP communication function (that is, IP communication controller 507) (T234). The RTP start includes additional information (a codec, an IP address, a port number, and SRTP). The IP communication function (that is, IP communication controller 507) transfers the RTP start instruction to application 50M (T235).

Upon receiving the RTP start instruction, application 50M instructs

RTP 510 (that is, controller 506) to release the port (T236). In response to the instruction, RTP 510 (that is, controller 506) releases the port (T237), and returns the release result to application 50M (T238). Application 50M transmits the result of the RTP start to the IP communication function (that is, IP communication controller 507) (T239). The result of the RTP start includes an IP address and a port number. The IP communication function (that is, IP communication controller 507) transmits the result of the RTP start to the IP communication function (that is, network I/F 20) (T240). The IP communication function (that is, network I/F 20) returns an Ack command indicating that synchronization with smartphone 50 is established as a response of the Invite command in procedure T225 (T241). RTP 40 (that is, CPU 11) releases the port (T242).

Application 50M of smartphone 50 displays talking screen gm9 describe above (see FIG. 11B) on touch panel 503 (T243). Application 50M makes a voice connection with RTP 510 (that is, controller 506) (T244). Thereafter, communication adapter 10 relays the voice data transferred between communication adapter 10 and smartphone 50 (T245).

When the user presses TRANSFER button bn2 to issue an instruction of transfer execution, the IP communication function (that is, network I/F 20) of communication adapter 10 executes transfer (T246). The IP communication function (that is, network I/F 20) transmits a Refer command indicating the transfer of the first call to PBX 8 (T247), and instructs PBX 8 to transfer the original communication (first call). PBX 8 returns a “202” command indicating acceptance of the instruction to the IP communication function (that is, network I/F 20) (T248). The IP communication function (that is, network I/F 20) transmits a “200” command indicating a response to PBX 8 (T249). PBX 8 transmits the BYE command to the IP communication function (that is, network I/F 20), and disconnects the voice call with the communication (second call) of the transfer destination (T250). The IP communication function (that is, network I/F 20) returns an Ack command indicating the disconnection response to PBX 8 (T251).

RTP 40 (that is, CPU 11) of communication adapter 10 closes the port (T252). The IP communication function (that is, network I/F 20) transmits call disconnection to the IP communication function (that is, IP communication controller 507) of smartphone 50 (T253). The IP communication function (that is, IP communication controller 507) transfers the call disconnection to application 50M (T254). Upon receiving the call disconnection instruction, application 50M disconnects the voice (T255), and instructs RTP 510 (that is, controller 506) to close the port (T256). RTP 510 (that is, controller 506) closes the port according to the instruction (T257), and returns the closing result of the port to application 50M (T258). Application 50M displays Idle screen gm6 (see FIG. 11D) on touch panel 503 (T258).

FIG. 11D is a diagram showing idle screen gm6.

Application 50M returns the call disconnection result to the IP communication function (that is, IP communication controller 507) (T260). The IP communication function (that is, IP communication controller 507) transfers the call disconnection result to the IP communication function (that is, network I/F 20) (T261). The IP communication function (that is, IP communication controller 507) shuts off the IP communication (T262).

PBX 8 transmits a BYE command to the IP communication function (that is, network I/F 20), and makes a notification of the disconnection of the voice call with the transfer source communication (an example of the first call) (T263). The IP communication function (that is, network I/F 20) returns an Ack command indicating the disconnection response to PBX 8 (T264).

As described above, in communication system 5 according to Exemplary Embodiment 2, PBX (an example of a telephone exchange) 8, smartphone 50 (an example of a telephone communication terminal), and communication adapter 10 that transmits and receives a signal about a call between PBX 8 and smartphone 50 are connected. When detecting an event related to a call such as an incoming call and an outgoing call, communication adapter 10 transmits information on the event to smartphone 50 through BLE communication (an example of the first communication) with smartphone 50. Smartphone 50 makes a notification of the occurrence of the event, based on the information on the event transmitted from communication adapter 10. After the notification of the occurrence of the event, communication adapter 10 transmits an Invite command, “180” command (a signal indicating completion of response preparation for an event), or the like to PBX 8.

Thus, communication system 5 can suppress deterioration in operability when a user's smartphone is used as a cordless telephone in business, and support improvement of operational efficiency, even for a user who is unfamiliar with a necessary operation according to the content of an event related to a call.

When detecting an event related to a call, communication adapter 10 transmits a signal for shifting smartphone 50 set in the standby mode to the active mode, to smartphone 50, by transmitting the IP communication information by the BLE communication (an example of the first communication). Smartphone 50 shifts from the standby mode to the active mode based on the signal for shifting to the active mode transmitted from communication adapter 10. Thus, communication adapter 10 shifts to the standby mode in a case where an incoming call, an outgoing call, or the like (an example of an event related to a call) is not detected, the power consumption of smartphone 50 can be suppressed.

In a case where a response operation of an event such as an incoming call or an outgoing call is performed, communication adapter 10 relays a signal about a voice call between smartphone 50 and another telephone communication terminal connected to PBX 8. Thus, since the communication adapter performs relaying, the user who possesses smartphone 50 can make an incoming call, an outgoing call, and the like by the same and simple operation as the normal operation.

Smartphone 50 displays a talking screen (an example of a screen related to a call) at the time of a voice call (that is, when a signal about a voice call is communicated). Thus, the user can check the call state, by looking at the screens related to a call, such as the incoming screen, the talking screen, and the outgoing call screen.

The event related to the call is an incoming call. Thus, the user can use the communication adapter in the incoming call.

When detecting the depression of CALL button bn1 (an example of an incoming call response operation), communication adapter 10 transmits a “200” command (a signal indicating the detection of an incoming call response operation) to PBX 8. Thus, the user can perform an incoming call response operation, on the communication adapter. For example, even in a situation where the smartphone cannot be taken out immediately while it is in the coat pocket, it is possible to respond to the incoming call using the communication adapter installed in the desk.

When detecting the depression of call start button sn6 (an example of an incoming call response operation), smartphone 50 transmits a “200” command (a signal indicating the detection of an incoming call response operation) to communication adapter 10. Thus, the user can perform the incoming call response operation, on the smartphone. Even if there is an incoming call in the communication adapter, the user can make an incoming call response, as usual, by using his or her smartphone. Therefore, the operation of the incoming call response is simple.

The event related to the call is an outgoing call. Thus, the user can use the communication adapter in the outgoing call.

When detecting the depression of CALL button bn1 (an example of an outgoing call operation), communication adapter 10 transmits an Invite command (a signal indicating detection of the outgoing call operation) to smartphone 50. Thus, the user can perform the outgoing call operation on the communication adapter. For example, even in a situation where the smartphone cannot be taken out immediately while it is in the coat pocket, it is possible to make a call using the communication adapter installed in the desk. The user can use the number of the other party registered in the communication adapter at the time of making a call.

When detecting the depression of TRANSFER button bn2 (an example of a transfer start operation), communication adapter 10 causes PBX 8 to hold a call with the telephone communication terminal of the current call partner. Thus, the user can perform a transfer start operation on the communication adapter. It is possible to hold a call with the telephone communication terminal of the current call partner, only by performing the transfer start operation, and the operation is simple.

Further, when detecting the input operation of the transfer destination number by 12-key 17, communication adapter 10 causes PBX 8 to start a call with the telephone communication terminal of the transfer destination. Thus, the user can perform an input operation of the transfer destination number on the communication adapter. Since the call with the telephone communication terminal of the current call partner is on hold, the user can slowly and calmly input the transfer destination number. When the input of the transfer destination number is ended, it is possible to start a call with the telephone communication terminal of the transfer destination, and communicate the purpose of transferring the call.

When detecting the depression of TRANSFER button bn2 (transfer execution operation), communication adapter 10 causes PBX 8 to perform a call between the telephone communication terminal of the current call partner which is on hold and the telephone communication terminal of the transfer destination. Thus, the user can perform a transfer execution operation on the communication adapter. A call can be transferred by simply performing the transfer execution operation, and the operation is simple. In this manner, the user can easily transfer the call on the user's smartphone to the telephone communication terminal of a transfer destination, simply by operating the communication adapter.

While various exemplary embodiments have been described with reference to the drawings, it is to be understood that the present disclosure is not limited thereto. It is apparent to those skilled in the art that changes and modifications are conceivable within the scope described in the claims, and it would be appreciated that those naturally belong to the technical scope of the present disclosure. Further, within the scope not deviating from the gist of the invention, respective constituent elements in the above exemplary embodiment may be arbitrarily combined.

The present disclosure is useful for a communication system, a communication method, and a communication adapter which suppress deterioration in operability when a user's smartphone is used as a cordless telephone in business, and support improvement of operational efficiency, even for a user who is unfamiliar with a necessary operation according to the content of an event related to a call.

What is claimed is:

1. A communication system comprising:
a telephone exchange;
a telephone communication terminal; and
a communication adapter that transmits and receives a signal about a call between the telephone exchange and the telephone communication terminal,
the telephone exchange, the telephone communication terminal, and the communication adapter being connected with each other,
wherein the communication adapter transmits information on an event to the telephone communication terminal by first communication with the telephone communication terminal, when detecting the event related to the call,
wherein the telephone communication terminal makes a notification of an occurrence of the event, based on the information on the event transmitted from the communication adapter, and
wherein the communication adapter transmits a signal indicating completion of response preparation for the event in the telephone communication terminal, to the telephone exchange, after the notification of the occurrence of the event.

2. The communication system of claim 1,
wherein the communication adapter transmits to the telephone communication terminal, a signal for shifting the telephone communication terminal which is set in a standby mode to an active mode, by the first communication, when detecting the event related to the call, and
wherein the telephone communication terminal is shifted to the active mode from the standby mode, based on the signal for shifting to the active mode, which is transmitted from the communication adapter.

3. The communication system of claim 1,
wherein the communication adapter relays a signal about a voice call between the telephone communication terminal and another telephone communication terminal connected to the telephone exchange, in a case where a response operation of the event is performed.

4. The communication system of claim 3,
wherein the telephone communication terminal displays a screen about a call, when the signal about the voice call is communicated.

5. The communication system of claim 3,
wherein the event related to the call is an incoming call.

6. The communication system of claim 5,
wherein when detecting a response operation of the incoming call, the communication adapter transmits a signal indicating the detection of the response operation of the incoming call to the telephone exchange.

7. The communication system of claim 5,
wherein when detecting a response operation of the incoming call, the telephone communication terminal transmits a signal indicating the detection of the response operation of the incoming call to the communication adapter.

8. The communication system of claim 3,
wherein the event related to the call is an outgoing call.

9. The communication system of claim 8,
wherein when detecting an operation for making the outgoing call, the communication adapter transmits a signal indicating the detection of the operation for making the outgoing call to the telephone communication terminal.

10. The communication system of claim 5,
wherein when detecting a transfer start operation, the communication adapter causes the telephone exchange to hold a call with a telephone communication terminal of a current call partner.

11. The communication system of claim 10,
wherein when detecting an input operation of a transfer destination number, the communication adapter causes the telephone exchange to start a call with a telephone communication terminal of a transfer destination.

12. The communication system of claim 11,
wherein when detecting a transfer execution operation, the communication adapter causes the telephone exchange to execute a call between the telephone communication terminal of the current call partner on hold and the telephone communication terminal of the transfer destination.

13. A communication method using a communication system in which a telephone exchange, a telephone communication terminal, and a communication adapter that transmits and receives a signal about a call between the telephone exchange and the telephone communication terminal are connected with each other, the method comprising:
transmitting information on an event to the telephone communication terminal by first communication with the telephone communication terminal, when detecting the event related to the call, using the communication adapter,
making a notification of an occurrence of the event, based on the information on the event transmitted from the communication adapter, using the telephone communication terminal; and
transmitting a signal indicating completion of response preparation for the event in the telephone communication terminal, to the telephone exchange, after the notification of the occurrence of the event, using the communication adapter.

14. A communication adapter connected to the communication system of claim 1.

15. A communication system comprising:
a telephone exchange;
a telephone communication terminal; and
a communication adapter that transmits and receives a signal about a call between the telephone exchange and the telephone communication terminal,
wherein the communication adapter performs a process for interconnection with the telephone communication terminal, between the telephone communication terminal and the communication adapter, by using first communication, when detecting an event related to connection with the telephone communication terminal,
wherein the telephone communication terminal transmits information on the telephone communication terminal to the communication adapter by using second communication, after the process for interconnection with the communication adapter, and
wherein the communication adapter transmits a signal indicating presence of a telephone communication terminal capable of performing the second communication with the communication adapter to the telephone exchange, based on information on the telephone communication terminal.

16. The communication system of claim 15,
wherein the telephone communication terminal and the communication adapter are provided for each user, and
wherein the telephone exchange includes a memory that stores a table retaining information indicating presence or absence of a telephone communication terminal using second communication with each communication adapter, for each of communication adapters connected to the telephone exchange, and updates the table, based on a signal indicating presence of a telephone communication terminal capable of performing the second communication, the signal being transmitted from at least one of the communication adapters.

17. The communication system of claim 15,
wherein the communication adapter makes a notification of presence of the telephone communication terminal that completes the process for interconnection, by using the first communication.

18. The communication system of claim 17,
wherein the communication adapter
includes a plurality of buttons each having a light emitting unit for indicating presence of the telephone communication terminal, for each telephone communication terminal,
registers the number of the telephone communication terminal corresponding to each of the plurality of buttons in a second memory, and
detects an event related to a connection with the telephone communication terminal having a number corresponding to the pressed button, in response to depression of each of the plurality of buttons.
